(19) United States
(12) Patent Application Publication
(10) Pub. No.: US 2004/0237509 A1
(43) Pub. Date: Dec. 2, 2004

(54) System and method for supplying clean pressurized air to diesel oxidation catalyst

(75) Inventors: Sameer Bhargava, Canton, MI (US); Kevin Dean Sisken, Saline, MI (US)

Correspondence Address: BROOKS KUSHMAN P.C., 1000 TOWN CENTER, TWENTY-SECOND FLOOR, SOUTHFIELD, MI, 48075, US

(73) Assignee: Detroit Diesel Corporation, Detroit, MI (US)

(21) Appl. No.: 10/447,845

(22) Filed: May 29, 2003

(51) Int. Cl. F01N 3/10; F01N 5/04; F02M 25/06

(52) U.S. Cl. 60/278; 60/280; 60/301

(57) ABSTRACT

A system for supplying clean pressurized air to a diesel oxidation catalyst (DOC) includes a diesel engine, a turbocharger, and a DOC. The diesel engine having an outlet that presents an exhaust gas. The turbocharger receives at least a first portion of the exhaust gas and clean air, and presents uncooled pressurized clean air. The DOC receives a combination of the at least first portion of the exhaust gas and at least a second portion of the uncooled pressurized clean air.

The invention was made with Government support under Contract No. DE-FC02-99EE50575. The Government has certain rights to the invention.

### BACKGROUND OF THE INVENTION

1. Field of the Invention

The present invention relates to a system and a method for supplying clean pressurized air to a diesel oxidation catalyst.

2. Background Art

Diesel oxidation catalysts (DOCs) are implemented to remove unburned hydrocarbons, non-methane hydrocarbons (NMHCs), and ammonia from diesel engine exhaust gas. In one example, DOCs can be implemented as a sole aftertreatment device. In another example, DOCs can be implemented in connection with a more comprehensive aftertreatment system. When the DOC is implemented in connection with a comprehensive aftertreatment system, the DOC is implemented in a diesel engine exhaust system downstream of a diesel particulate filter (DPF), a lean NOₓ trap (LNT), and/or a selective catalytic reduction (SCR) device.

A LNT performs reduction of oxides of nitrogen (NOₓ) to nitrogen (N₂). The LNT is a trap where the NOₓ is converted to NO₂ and the NO₂ is stored. The LNT provides a limited space to store the NO₂ and so the LNT is regenerated. During the regeneration of the LNT, the NO₂ is released and converted to N₂. To regenerate an LNT, gas flow through the LNT is oxygen free (i.e., fuel rich). A fuel rich exhaust gas flow can be generated by injecting excess fuel in either of at least one cylinder of the engine or in the exhaust system. To properly regenerate a conventional LNT, the regeneration operation is performed at every 30 to 120 seconds of engine operation, the regeneration event typically lasts 3 to 5 seconds.

Since injecting excess fuel in at least one cylinder of the engine causes an air/fuel mixture that is rich, not all of the fuel is typically oxidized and unburned hydrocarbons result. Since hydrocarbons are a regulated exhaust emission, at least one DOC is typically implemented to remove the unburned hydrocarbons from the exhaust gas. However, the DOC is unable to remove the unburned hydrocarbons unless oxygen is available to oxidize the unburned hydrocarbons.

Thus, there exists a need for an improved system and an improved method for supplying oxygen to a DOC and improve (i.e., lower, reduce, etc.) the level of unwanted diesel exhaust gas emissions. The improved system and method for supplying oxygen (i.e., clean pressurized air) to a diesel engine exhaust DOC of the present invention generally provides less unwanted emissions and reduced fuel consumption when compared to conventional approaches.

### SUMMARY OF THE INVENTION

The present invention generally provides new, improved and innovative system and method for supplying oxygen (i.e., clean pressurized air) to a diesel engine exhaust DOC and improve (i.e., lower, reduce, etc.) the level of unwanted diesel exhaust gas emissions. The present invention may provide clean pressurized air (i.e., oxygen) from the inlet side of the engine to the exhaust stream ahead of the DOC to oxidize unburned hydrocarbons in the exhaust gas. The present invention may provide for reducing the amount of air at the inlet side of the engine and, thus, less fuel may be injected into the engine to provide the fuel rich condition during the LNT regeneration process when compared to conventional approaches, and, in some cases, no additional fuel may be required during the LNT regeneration process. As such, the improved system and method for supplying oxygen (i.e., clean pressurized air) to a diesel engine exhaust DOC of the present invention generally provides less unwanted emissions and reduced fuel consumption when compared to conventional approaches.

According to the present invention, a system for supplying clean pressurized air to a diesel oxidation catalyst (DOC) is provided. The system comprises a diesel engine having an outlet that presents an exhaust gas, a turbocharger that receives at least a first portion of the exhaust gas and clean air and presents uncooled pressurized clean air, and a DOC that receives a combination of the at least first portion of the exhaust gas and at least a second portion of the uncooled pressurized clean air.

Also according to the present invention, another system for supplying clean pressurized air to a diesel oxidation catalyst (DOC) is provided. The system comprises a diesel engine having an outlet that presents an exhaust gas, a turbocharger that receives at least a first portion of the exhaust gas and clean air and presents uncooled pressurized clean air to a charge air cooler, the charge air cooler cools the pressurized clean air, and a DOC that receives a combination of the at least first portion of the exhaust gas and at least a second portion of the cooled pressurized clean air.

Further, according to the present invention, a method for supplying clean pressurized air to a diesel oxidation catalyst (DOC) is provided. The method comprising providing a diesel engine having an outlet that presents an exhaust gas, presenting at least a first portion of the exhaust gas and clean air to a turbocharger that presents uncooled pressurized clean air, combining the at least first portion of the exhaust gas and at least a second portion of the uncooled pressurized clean air, and presenting the combination of the at least first portion of the exhaust gas and at least second portion of the uncooled pressurized clean air to a DOC.

The above features, and other features and advantages of the present invention are readily apparent from the following detailed descriptions thereof when taken in connection with the accompanying drawings.

### BRIEF DESCRIPTION OF THE DRAWINGS

FIG. 1 is a diagram of a diesel engine system according to the present invention;

FIG. 2 is a diagram of another diesel engine system according to the present invention; and

FIG. 3 is a diagram of yet another diesel engine system according to the present invention.

### DETAILED DESCRIPTION OF THE PREFERRED EMBODIMENT(S)

With reference to the Figures, the preferred embodiments of the present invention will now be described in detail. Generally, the present invention provides an improved system and method for supplying clean pressurized air (i.e., oxygen) to a diesel oxidation catalyst (DOC). The present invention may be implemented to supply oxygen to oxidize unburned hydrocarbons in the exhaust gas.

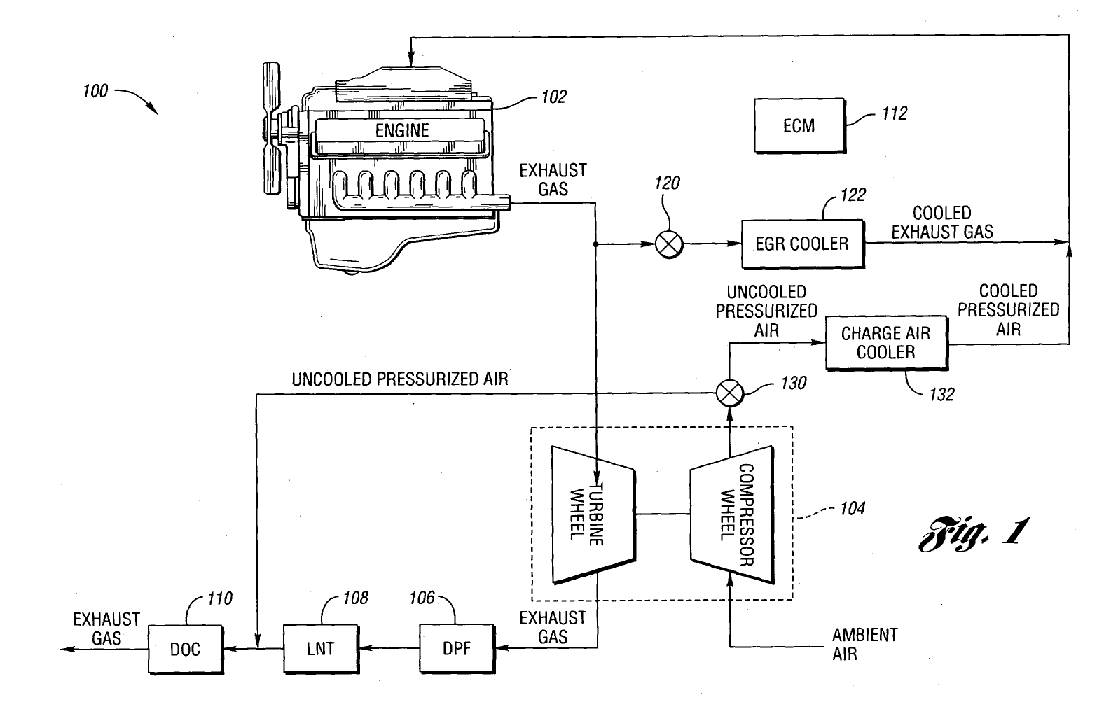

Referring to FIG. 1, a diagram illustrating an example of a system 100 in accordance with the present invention is shown. The system 100 generally comprises a system for supplying clean pressurized air (i.e., oxygen) to a diesel oxidation catalyst (DOC). In one example, the system 100 generally comprises a diesel engine 102 that generates an exhaust gas. At least a first portion of the exhaust gas may be routed to an exhaust gas inlet (i.e., a turbine wheel inlet) of a turbocharger 104.

The turbocharger 104 may have an exhaust gas outlet that may be connected to an inlet side of a diesel particulate filter (DPF) 106 such that, in one flow path, the at least first portion of the exhaust gas may flow from the turbocharger 104 to the DPF 106. An outlet of the DPF 106 may be connected to an inlet of a lean NOₓ trap (LNT) 108 such that the at least first portion of the exhaust gas may flow through the DPF 106 to the LNT 108. An outlet of the LNT 108 may be connected to an inlet of a diesel oxidation catalyst (DOC) 110 such that the at least first portion of the exhaust gas may flow through the LNT 108 to the DOC 110. The at least first portion of the exhaust gas generally flows through the DOC 110 and may be presented into atmosphere.

In another exhaust gas flow path, the exhaust gas outlet of the engine 102 may also be connected to provide at least a second portion (e.g., a remainder) of the exhaust gas flow to an inlet of a valve 120. An outlet of the valve 120 may be connected to an inlet of an exhaust gas recirculation (EGR) cooler 122 such that the at least second portion of the exhaust gas may flow from the engine 102 into the EGR cooler 122 when the valve 120 is opened. The EGR cooler 122 generally cools the at least second portion of the exhaust gas (i.e., the cooler 122 may be configured to cool the at least second portion of the exhaust gas).

The turbocharger 104 generally has an ambient air (i.e., compressor wheel) inlet that may receive ambient (i.e., clean) air from the atmosphere where the system 100 is implemented and generate an uncooled clean pressurized air flow (i.e., a charge air flow) that may be presented at an air outlet that may be connected to an inlet of a valve 130. The valve 130 may have a first outlet that may be connected to an inlet of a charge air cooler 132 such that at least a first portion of the uncooled clean pressurized air may flow to the cooler 132 when the valve 130 directs the at least first portion of the uncooled pressurized clean air flow to the cooler 132.

The at least first portion of the uncooled pressurized clean air may flow through the cooler 132. The charge air cooler 132 generally cools the at least first portion of the uncooled pressurized clean air (i.e., the cooler 132 may be configured to cool the at least first portion of the uncooled pressurized clean air). An outlet of the cooler 132 may present cooled pressurized clean air that may flow into an inlet of the engine 102. The at least second portion of the exhaust gas may flow through the EGR cooler 122 and may be combined with (e.g., injected into) the cooled pressurized clean air that flows into the engine 102.

The valve 130 may have a second outlet that may direct at least a second portion (i.e., a remainder) of the uncooled clean pressurized air into the at least first portion of the exhaust gas that flows into and through the DOC 110 after the LNT 108. The uncooled pressurized air that is directed into (i.e., combined with) the at least first portion of the exhaust gas that flows through the DOC 110 may provide oxygen to the at least first portion of the exhaust gas such that the DOC 110 may oxidize unburned hydrocarbons in the at least first portion of the exhaust gas that is presented to the atmosphere by the DOC 110.

The system 100 generally includes an engine control module (ECM) or a powertrain control module (PCM) 112 that may control various modes of operation of the system 100 and the respective components. The ECM (or PCM) 112 generally controls the operation of the engine 102 and the fuel provided thereto, and the operation (i.e., regulation, modulation, opening and closing, etc.) of the valves 120 and 130. For example, regulation of the valve 120 generally controls a timing of and an amount of the at least second portion of the exhaust gas presented by the EGR cooler 122 that may be combined (as cooled exhaust gas) with the cooled pressurized clean air presented by the cooler 132, and presented to the inlet of the engine 102. The valve 130 may control a timing of and an amount of the uncooled pressurized air presented by the turbocharger 104 that is presented to the cooler 132, and a timing of and an amount of the uncooled pressurized air presented by the turbocharger 104 that is combined with the exhaust gas that flows through the DOC 110.

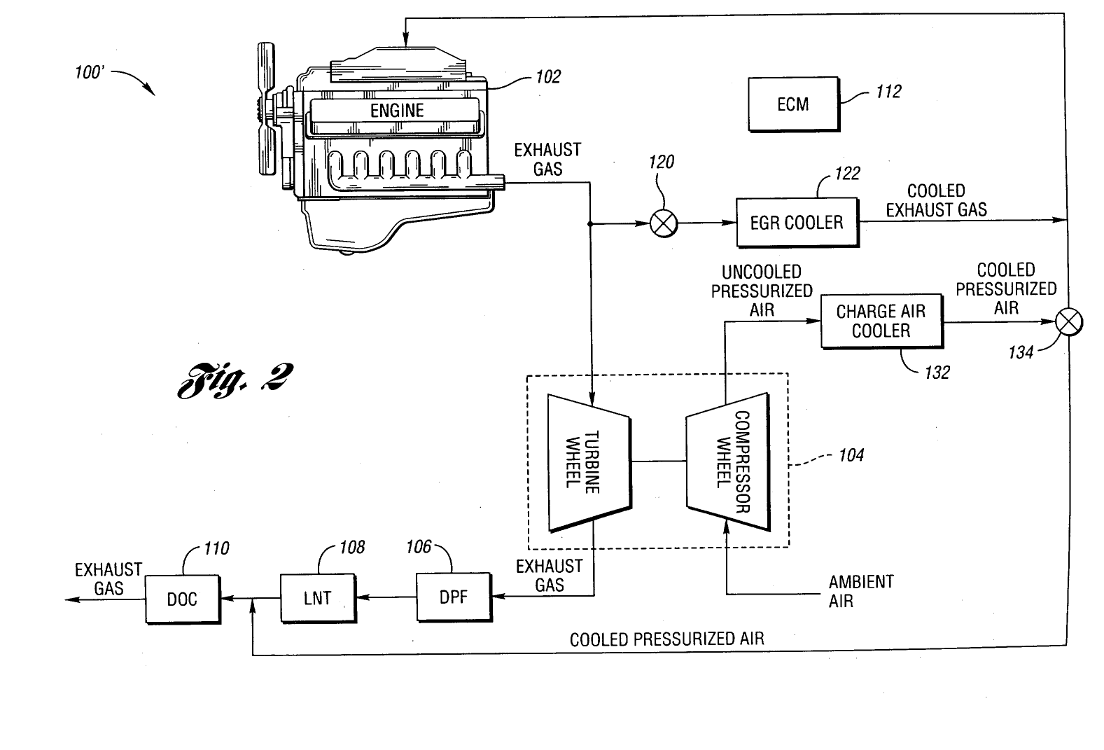

Referring to FIG. 2, a diagram illustrating a system 100′ in accordance with the present invention is shown. The system 100′ may be implemented similarly to the system 100. The valve 130 may be deleted and the uncooled clean pressurized air may flow from the respective outlet of the turbocharger 104 directly into the cooler 132. The uncooled pressurized air presented by the turbocharger 104 may not be directed into the at least first portion of the exhaust gas that flows into the DOC 110. The cooler 132 may cool the uncooled pressurized clean air presented by the turbocharger 104.

The outlet of the cooler 132 may be connected to an inlet of a valve 134 such that the cooled clean pressurized air that flows from the cooler 132 may flow into the valve 134. The valve 134 may direct at least a first portion of the cooled pressurized air into the inlet of the engine 102. The valve 134 may direct (or inject) at least a second portion (i.e., a remainder) of the cooled clean pressurized air from the cooler 132 into the at least first portion of the exhaust gas that flows into and through the DOC 110 after the LNT 108. The cooled pressurized air that is directed into (i.e., combined with) the at least first portion of the exhaust gas that flows into the DOC 110 may oxidize unburned hydrocarbons in the at least first portion of the exhaust gas that is presented to the atmosphere by the DOC 110.

The ECM (or PCM) 112 generally controls the operation of the engine 102 and the fuel provided thereto, and the operation of the valves 120 and 134. The valve 134 may control a timing of and an amount of the cooled pressurized air presented by the cooler 132 that is presented to the engine 102, and a timing of and an amount of the cooled pressurized air presented by the cooler 132 that is combined with the at least first portion of the exhaust gas that flows through the DOC 110.

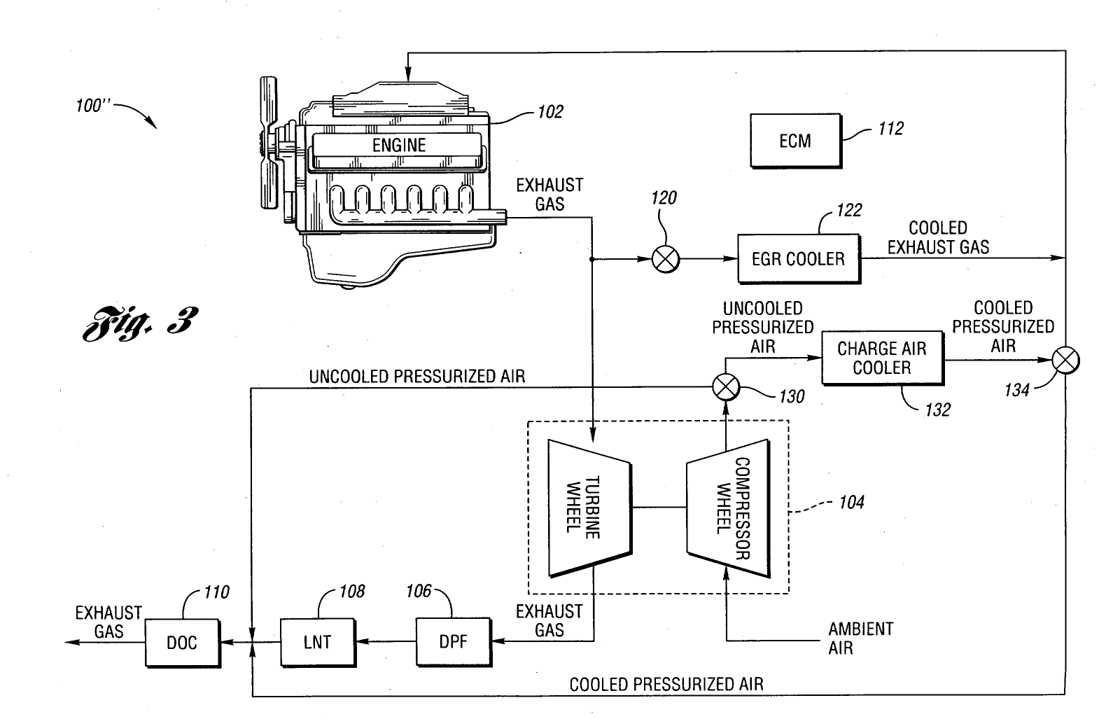

Referring to FIG. 3, a diagram illustrating a system 100″ in accordance with the present invention is shown. The system 100″ may be implemented similarly to the systems 100 and 100′. The system 100″ is generally implemented as a combination of the systems 100 and 100′.

In one mode of operation the system 100″ (i.e., the valve 130) may direct the at least second portion of the uncooled clean pressurized air from the turbocharger 104 into the at least first portion of the exhaust gas that flows into and through the DOC 110 after the LNT 108. In another mode of operation, the system 100″ (i.e., the valve 134) may direct (or inject) at least a second portion of the cooled clean pressurized air from the charge air cooler 132 into and through the at least first portion of the exhaust gas that flows into the DOC 110 after the LNT 108. In yet another mode of operation, the system 100″ (i.e., the valves 130 and 134) may modulate (or control) directing at least a second portion of the uncooled clean pressurized air into the at least first portion of the exhaust gas that flows into and through the DOC 110 and directing at least a second portion of the cooled clean pressurized air into the at least first portion of the exhaust gas that flows into and through the DOC 110 such that the operation of the system 100″ may be optimized for minimal unwanted exhaust emissions. The ECM (or PCM) 112 generally controls the operation of the engine 102 and the fuel provided thereto, and the operation of the valves 120, 130 and 134.

As is readily apparent from the foregoing description, then, the present invention generally provides an improved system (e.g., the systems 100, 100′, and/or 100″) and method for supplying clean pressurized air (i.e., oxygen) to a DOC (e.g., the DOC 110) and improve (i.e., lower, reduce, etc.) the level of unwanted diesel exhaust gas emissions. The present invention may provide cooled, uncooled, or a combination of cooled and uncooled clean pressurized air (i.e., oxygen) from the inlet side of the engine 102 to the exhaust stream ahead of the DOC 110. In one mode of operation, the present invention may provide clean pressurized air (i.e., oxygen) from the inlet side of the engine 102 to the exhaust stream ahead of the DOC 110 to oxidize unburned hydrocarbons in the exhaust gas. In another mode of operation, the present invention may provide for reducing the amount of air at the inlet side of the engine 102 and, thus, less fuel may be injected into the engine 102 to provide the fuel rich condition during the LNT regeneration process (e.g., regeneration of the LNT 108) when compared to conventional approaches, and, in some cases, no additional fuel may be required during the LNT regeneration process. As such, the improved system and method for supplying oxygen (i.e., clean pressurized air) to a diesel engine exhaust DOC of the present invention generally provides less unwanted emissions and reduced fuel consumption when compared to conventional approaches.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for supplying clean pressurized air to a diesel oxidation catalyst (DOC), the system comprising:
a diesel engine having an outlet that presents an exhaust gas;
a turbocharger that receives at least a first portion of the exhaust gas and clean air, and presents uncooled pressurized clean air; and
a DOC that receives a combination of the at least first portion of the exhaust gas and at least a second portion of the uncooled pressurized clean air.

2. The system of claim 1 further comprising a first valve that controls a timing of and an amount of the at least second portion of the uncooled pressurized clean air that is combined with the at least a first portion of the exhaust gas.

3. The system of claim 2 wherein the first valve further controls a timing of and an amount of a first portion of the uncooled pressurized clean air that is presented to a charge air cooler, the charge air cooler cools the pressurized clean air, and at least a first portion of the cooled pressurized clean air is presented to an inlet of the engine.

4. The system of claim 3 further comprising a second valve that controls a timing of and an amount of a second portion of the exhaust gas that is presented to an exhaust gas recirculation (EGR) cooler, the EGR cooler cools the second portion of the exhaust gas, and the cooled exhaust gas is combined with the first portion of the cooled pressurized clean air and presented to the inlet of the engine.

5. The system of claim 1 further comprising a diesel particulate filter (DPF) connected to a lean NOₓ trap (LNT) and the LNT is connected to the DOC, wherein the DPF receives the first portion of the exhaust gas from the turbocharger, and the at least first portion of the exhaust gas and the at least second portion of the uncooled pressurized clean air are combined between the LNT and the DOC.

6. The system of claim 4 further comprising a third valve that controls a timing of and an amount of a second portion of the cooled pressurized clean air that is combined with the at least first portion of the exhaust gas.

7. The system of claim 6 further comprising an engine control module that controls operation of the first, second, and third valves.

8. A system for supplying clean pressurized air to a diesel oxidation catalyst (DOC), the system comprising:
a diesel engine having an outlet that presents an exhaust gas;
a turbocharger that receives at least a first portion of the exhaust gas and clean air, presents uncooled pressurized clean air to a charge air cooler, and the charge air cooler cools the pressurized clean air; and
a DOC that receives a combination of the at least first portion of the exhaust gas and at least a second portion of the cooled pressurized clean air.

9. The system of claim 8 further comprising a first valve that controls a timing of and an amount of the at least second portion of the cooled pressurized clean air that is combined with the at least first portion of the exhaust gas.

10. The system of claim 10 wherein the at least first valve further controls a timing of and an amount of a first portion of the cooled pressurized clean air that is presented to an inlet of the engine.

11. The system of claim 10 further comprising a second valve that controls a timing of and an amount of a second portion of the exhaust gas that is presented to an exhaust gas recirculation (EGR) cooler, the EGR cooler cools the second portion of the exhaust gas, and the cooled exhaust gas is combined with the first portion of the cooled pressurized clean air and presented to the inlet of the engine.

12. The system of claim 8 further comprising a diesel particulate filter (DPF) connected to a lean NOₓ trap (LNT) and the LNT is connected to the DOC, wherein the DPF receives the first portion of the exhaust gas from the turbocharger, and the at least first portion of the exhaust gas and the at least second portion of the cooled pressurized clean air are combined between the LNT and the DOC.

13. The system of claim 11 further comprising an engine control module that controls operation of the first and second valves.

14. A method for supplying clean pressurized air to a diesel oxidation catalyst (DOC), the method comprising:
providing a diesel engine having an outlet that presents an exhaust gas;
presenting at least a first portion of the exhaust gas and clean air to a turbocharger that presents uncooled pressurized clean air;
combining the at least first portion of the exhaust gas and at least a second portion of the uncooled pressurized clean air; and
presenting the combination of the at least first portion of the exhaust gas and at least second portion of the uncooled pressurized clean air to a DOC.

15. The method of claim 14 further comprising controlling a timing of and an amount of the at least second portion of the uncooled pressurized clean air that is combined with the at least first portion of the exhaust gas using a first valve.

16. The method of claim 15 further comprising:
controlling a timing of and an amount of a first portion of the uncooled pressurized clean air that is presented to a charger air cooler using the first valve, wherein the charge air cooler cools the pressurized clean air; and
presenting at least a first portion of the cooled pressurized clean air to an inlet of the engine.

17. The method of claim 16 further comprising:
controlling a timing of and an amount of a second portion of the exhaust gas that is presented to an exhaust gas recirculation (EGR) cooler using a second valve, wherein the EGR cooler cools the second portion of the exhaust gas; and
combining the cooled exhaust gas with the cooled pressurized clean air and presenting the combination of the cooled exhaust gas and the cooled pressurized clean air to the inlet of the engine.

18. The method of claim 14 further comprising:
connecting a diesel particulate filter (DPF) to a lean NOₓ trap (LNT) and connecting the LNT to the DOC, wherein the DPF receives the first portion of the exhaust gas from the turbocharger; and
combining the at least a first portion of the exhaust gas and the at least second portion of the uncooled pressurized clean air between the LNT and the DOC.

19. The method of claim 14 further comprising controlling a timing of and an amount of a second portion of the cooled pressurized clean air that is combined with the at least first portion of the exhaust gas using a third valve.

20. The method of claim 19 further comprising controlling operation of the first, second, and third valves using an engine control module.
